(19) United States
(12) Patent Application Publication
(10) Pub. No.: US 2024/0375303 A1
(43) Pub. Date: Nov. 14, 2024

(54) RAZOR

(71) Applicants: Komninos George ANGELOS, Gauteng (ZA); Allen Preston LAWRENCE, Gauteng (ZA)

(72) Inventor: Allen Preston LAWRENCE, Gauteng (ZA)

(73) Assignees: Komninos George ANGELOS, Gauteng (ZA); Allen Preston LAWRENCE, Gauteng (ZA)

(21) Appl. No.: 18/691,892

(22) PCT Filed: Sep. 14, 2021
(86) PCT No.: PCT/IB2021/058363

§ 371 Date: Mar. 14, 2024

(30) Foreign Application Priority Data
Sep. 14, 2020 (ZA) 2020/05685

(51) Int. Cl. B26B 21/28; B26B 21/56

(52) U.S. Cl. CPC B26B 21/28; B26B 21/565

(57) ABSTRACT

A razor is provided comprising a razor cartridge fitted with at least one razor blade having a cutting edge which is curved, when viewed in plan, and arced, when viewed from the front, the razor blade being angled relative to a surface to be shaved, the curved cutting edge defining an arc with two ends and a midpoint. The orientation of the razor cartridge is movable between a first position, in the case of a flat surface to be shaved, in which the two ends and the midpoint of the arc are on the same plane to define a flat shaving profile; a second position, in the case of a convex surface to be shaved, in which the midpoint of the arc is lifted relative to the two ends of the arc, to define a convex shaving profile; and a third position, in the case of a concave surface to be shaved, in which the midpoint of the arc is lowered relative to the two ends of the arc, to define a concave shaving profile.

### FIELD OF INVENTION

THIS invention relates to a razor, the razor comprising a razor cartridge (sometimes call a razor head) fitted with at least one razor blade, with the razor cartridge typically being fitted to a handle for use by a user.

### BACKGROUND OF INVENTION

Razors are used by both males and females for the removal of body hair. To this end, there are many variations available, some having a single razor blade but most using a multiple razor blade arrangement in which the blades are set slightly apart from each other in a parallel arrangement having their cutting edges in flat alignment. In the multiple razor blade arrangement, the multiple blades define a flat plane at their cutting edges. The greater the number of blades the wider the flat plane that is formed by their cutting edges. The advantage to having multiple blades is that every stroke of the razor will present multiple cutting edges which are able to remove hair and to some degree will simulate an equivalent number of razor strokes as the number of blades. For example, 2 blades equate to two strokes and 5 blades will equate to five strokes of a razor with a single blade.

Upon closer examination of the above practical shaving description in relationship to the profiles, contours and curves of the skin where shaving is applied, several important factors are apparent. The cutting edge/s of the razor/s form straight lines between their ends, which make them best suited to perfectly flat surfaces to achieve optimum shaving. Various views of this arrangement is shown in FIG. 1, which show that a conventional straight razor blade 10 is best suited to perfectly flat planar surfaces 12. As can be seen there is full blade contact along the cutting edge onto the perfectly flat planar surface 12. Conversely, it is clear that the conventional straight razor blade 10 cannot adapt to convex and concave profiles. In particular, when considering the areas of the body where shaving is performed, there are no perfectly flat planar surfaces. In fact, the surfaces of the human body that require shaving are a conglomeration of complex concave and convex profiles, contours and curves in a random arrangement. Typically, pressure is applied during the shaving action to flatten the area immediately under the cutting edge/s where efficient shaving may occur albeit over a very narrow band. The progressive movement of this direction of shaving forms cleanly shaven bands adjacent to one another. The amount of pressure applied can also affect the width of the band but can be detrimental to the skin where the pressure is greatest. Practical experience also brings one to the same conclusion, where there is bone tissue under the skin around the chin, the amount of deformation by pressure is limited and it becomes difficult to achieve a clean close shave evenly. Similarly, areas as in the case of the cheeks and neck where the pressure deforms the skin inwardly, the same result is experienced.

The objective of the present invention is to address the above shortcomings associated with conventional straight razor blades. In particular, the objective is to provide a razor with one or more blades that will dynamically adjust and adapt during the shaving action to conform to the conglomeration of skin profiles, contours and curves which are characteristic of facial and body profiles where shaving is performed. In addition, the objective will be achieved without the repeated shaving action associated with a narrow band width which is cleanly shaven, and also with no need to exert undue pressure.

### SUMMARY OF INVENTION

According to the invention there is provided a razor comprising a razor cartridge fitted with at least one razor blade having a cutting edge which is curved, when viewed in plan, and arced, when viewed from the front, the razor blade being angled relative to a surface to be shaved, the curved cutting edge defining an arc with two ends and a midpoint, the orientation of the razor cartridge being movable between a first position, in the case of a flat surface to be shaved, in which the two ends and the midpoint of the arc are on the same plane to define a flat shaving profile, corresponding to the flat surface to be shaved; a second position, in the case of a convex surface to be shaved, in which the midpoint of the arc is lifted relative to the two ends of the arc, to define a convex shaving profile, corresponding to the convex surface to be shaved; and a third position, in the case of a concave surface to be shaved, in which the midpoint of the arc is lowered relative to the two ends of the arc, to define a concave shaving profile, corresponding to the concave surface to be shaved.

In an embodiment, the razor blade includes a razor blade flange extending transversely to the curved cutting edge, to facilitate fitment of the razor blade to the razor cartridge.

In an embodiment, a plurality of razor blades are fitted to the razor cartridge, the razor cartridge in turn being removably securable to a handle.

In one version, the razor cartridge is fixed relative to the handle, in which the shaving profiles corresponding to the first, second and third positions are achieved by varying the angle of the handle, and thus the razor cartridge.

In another version, the razor includes a pivoting arrangement to automatically pivot the razor blade between the first, second and third positions, as the razor slides across the surface being shaved.

In an embodiment, the pivoting arrangement includes spaced apart, inwardly facing pins extending from head securing arms provide at a razor cartridge end of the handle, the pins being arranged to accommodate complementary recesses define in end side walls of the razor cartridge.

In an embodiment, the pins define a pixot axis therebetween being spaced from the curved cutting edge of the razor blade (the pivot axis thus being parallel to a chord defined between the two ends of the arc).

The shape of the blade, in conjunction with the pivoting arrangement, is such that the midpoint of the arc can move freely either up or down, relative to the two ends of the arc, to permit the razor to accommodate flat surfaces as well as a conglomeration of both concave and convex shapes, curves and forms. It is thus evident that a razor with a curved blade when mounted on a pivot axis and allowed to swivel freely ensures that a balance is maintained between the contact of the ends and the midpoint of the curved blade, keeping it in contact with the skin being shaved. The swivel movement permits infinitely variable convex and concave shapes, curves and profiles to be accommodated automatically.

### BRIEF DESCRIPTION OF DRAWINGS

The objects of this invention and the manner of obtaining them, will become more apparent, and the invention itself will be better understood, by reference to the following description of embodiments of the invention taken in conjunction with the accompanying diagrammatic drawings, wherein:

FIG. 1 shows a conventional straight razor blade, which is best suited to perfectly flat planar surfaces;

FIG. 2 shows various views of a razor blade according to the invention, in its most basic, conceptual form, the razor blade having a curved cutting edge, when viewed in plan, and an arced cutting edge, when viewed from the front and rear, the curved cutting edge defining an arc with two ends and a midpoint;

FIG. 3 shows various views of the razor blade according to the invention, orientated in a first position, in the case of a flat surface to be shaved, in which the two ends and the midpoint of the arc are on the same plane to define a flat shaving profile, corresponding to the flat surface to be shaved;

FIG. 4 shows an underside view of the razor blade shown in FIG. 3, fitted to a handle (with a razor cartridge that would hold the razor blade being omitted for clarity);

FIG. 5 shows a side view of the razor blade shown in FIG. 3, fitted to a handle;

FIG. 6 shows a front view of the razor blade shown in FIG. 3, fitted to a handle;

FIG. 7 shows a perspective view of the razor blade shown in FIG. 3, fitted to a razor cartridge in use, with reference to a flat surface (with the handle being omitted for clarity);

FIG. 8 shows various views of the razor blade according to the invention, orientated in a second position, in the case of a convex surface to be shaved, in which the midpoint of the arc is lifted relative to the two ends of the arc, to define a convex shaving profile, corresponding to the convex surface to be shaved;

FIG. 9 shows an underside view of the razor blade shown in FIG. 8, fitted to a handle (with a razor cartridge that would hold the razor blade being omitted for clarity);

FIG. 10 shows a side view of the razor blade shown in FIG. 8, fitted to a handle;

FIG. 11 shows a front view of the razor blade shown in FIG. 8, fitted to a handle;

FIG. 12 shows a perspective view of the razor blade shown in FIG. 8, fitted to a razor cartridge, with reference to a convex surface (with the handle being omitted for clarity);

FIG. 13 shows various views of the razor blade according to the invention, orientated in a third position, in the case of a concave surface to be shaved, in which the midpoint of the arc is lowered relative to the two ends of the arc, to define a concave shaving profile, corresponding to the concave surface to be shaved;

FIG. 14 shows an underside view of the razor blade shown in FIG. 13, fitted to a handle (with a razor cartridge that would hold the razor blade being omitted for clarity);

FIG. 15 shows a side view of the razor blade shown in FIG. 13, fitted to a handle;

FIG. 16 shows a front view of the razor blade shown in FIG. 13, fitted to a handle (with a razor cartridge that would hold the razor blade being omitted for clarity); and

FIG. 17 shows a perspective view of the razor blade shown in FIG. 13, fitted to a razor cartridge, with reference to a convex surface (with the handle being omitted for clarity).

### DETAILED DESCRIPTION OF AN EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

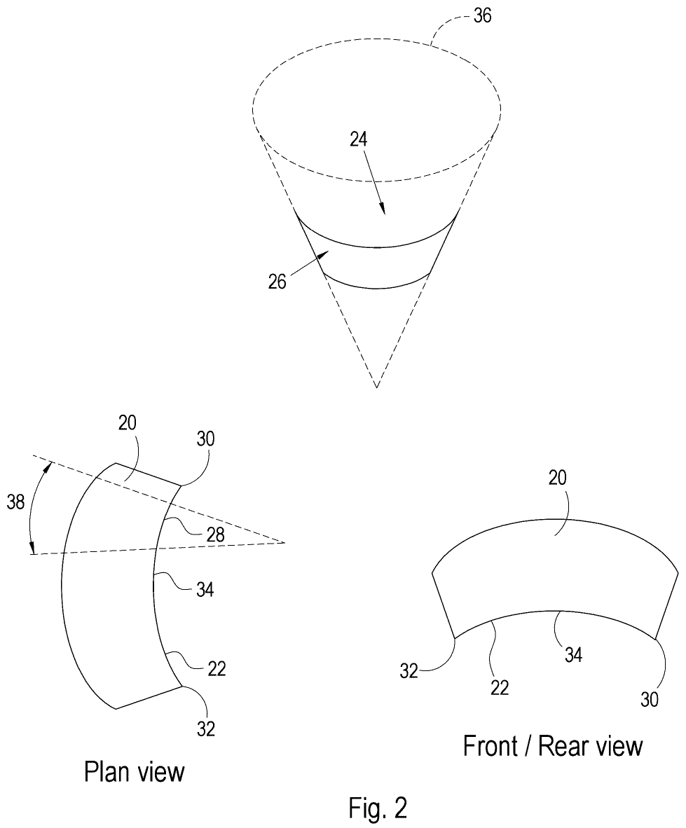

Referring first to FIG. 2, in one version, the present invention provides a razor blade 20 for a razor cartridge for a razor. The razor blade 20 has a cutting edge 22 which is curved, when viewed in plan (as shown by arrow 24), and arced, when viewed from the front and rear (as shown by arrow 24). The curved and arced cutting edge 22 defines an arc 28 with two ends 30, 32 and a midpoint 34.

As shown by dotted outline 36, the razor blade 20 is a segment of a regular cone 36, cut or formed so as to define both a curved (when viewed in plan) and arced (when viewed from the front/rear) cutting edge 22. The material of choice is typically 0.1 mm stainless steel, to provide sufficient flexibility for molding purposes without needing any preforming. The razor blade 20 is thus a segment of a regular cone and the developed profile for such a form is, in this example, taken to have a rake angle 38 of 40 degrees, to enable efficient cutting.

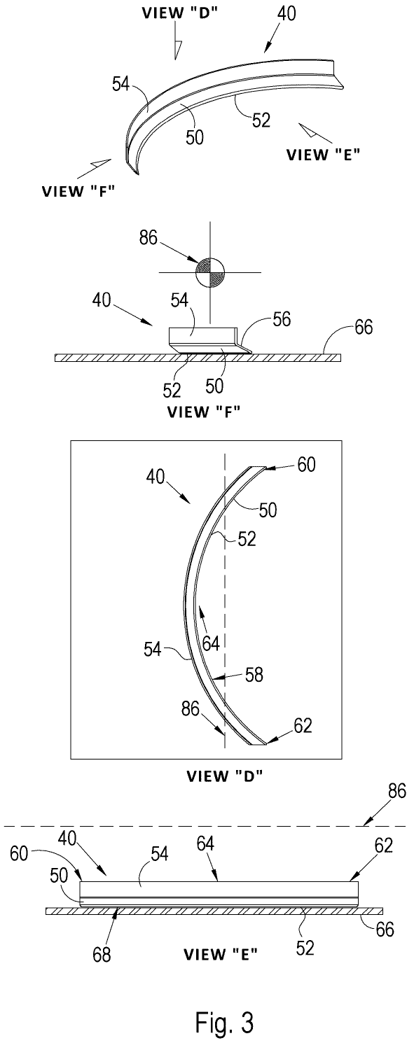

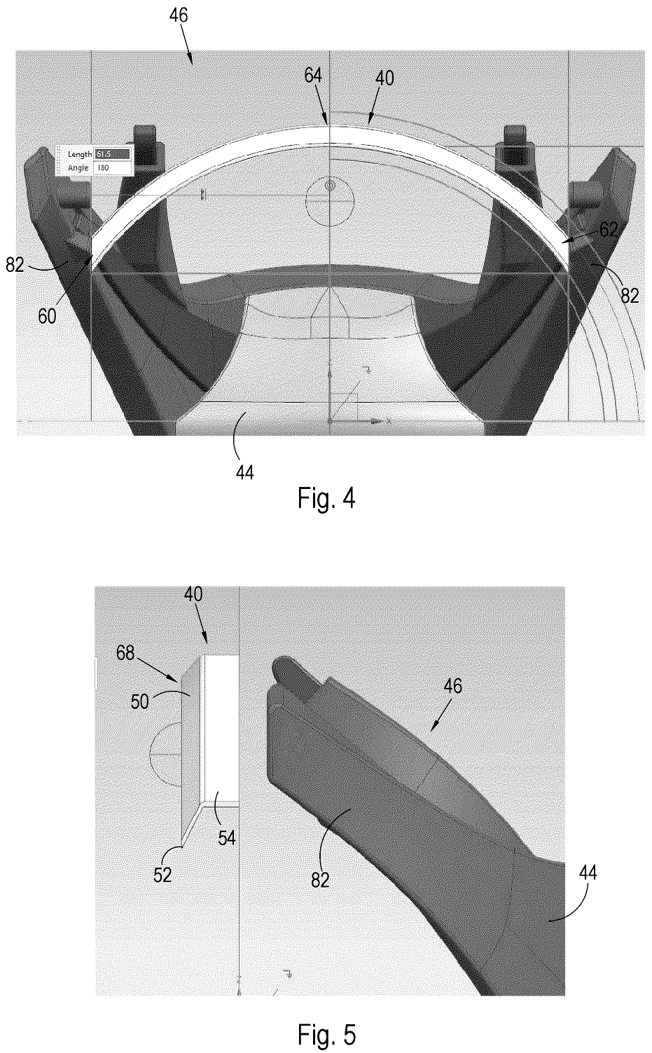

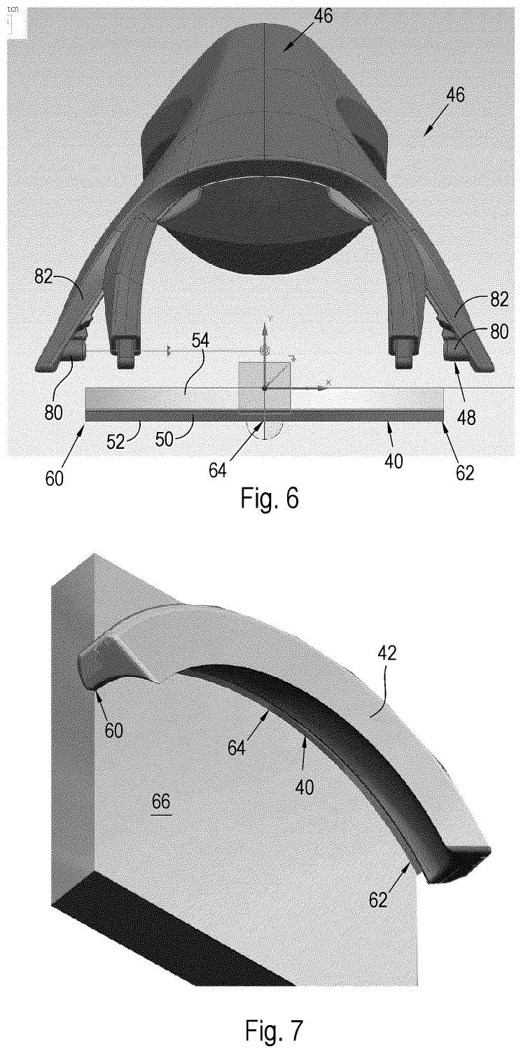

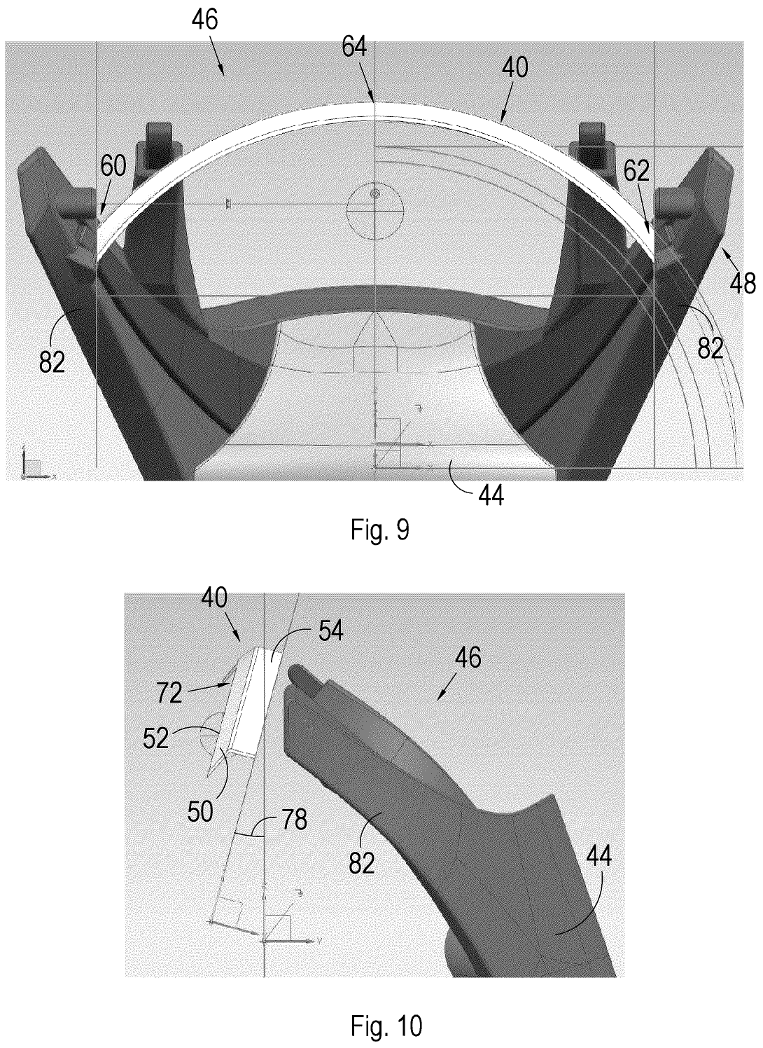

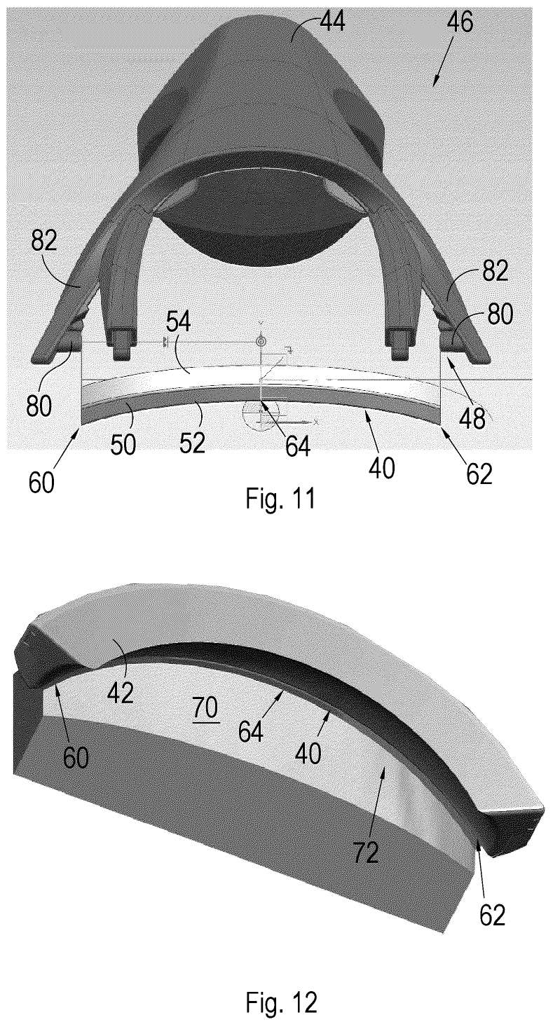

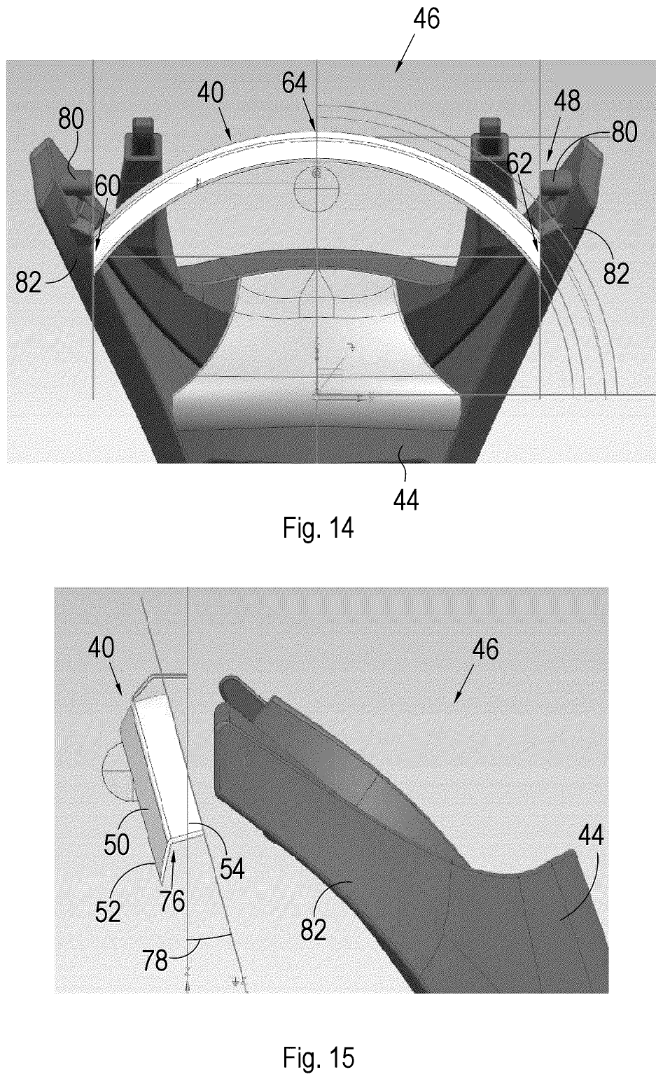

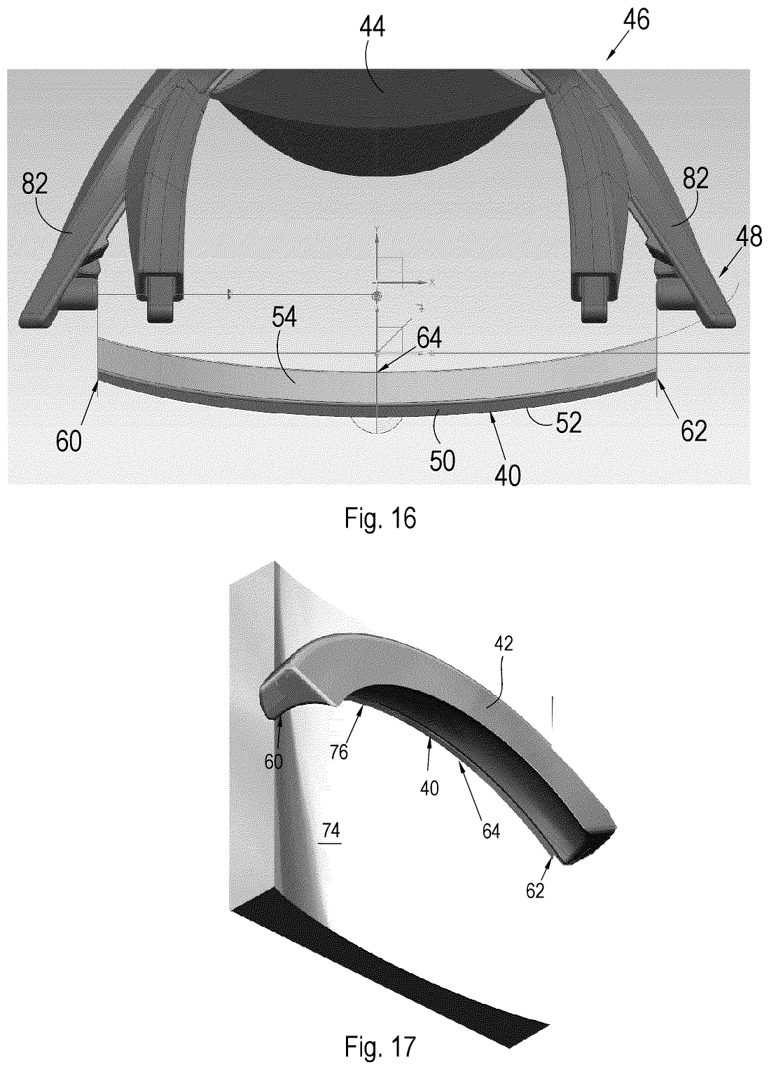

Turning now to the remaining FIGS. 3 to 17, a more practical version of a razor blade 40 is shown. As will become clear, one or more razor blades 40 are fitted to a razor cartridge 42 (as best shown in FIGS. 7, 12 and 17), which in turn is fitted to a handle 44 (as best shown in FIGS. 4 to 6, 9 to 11, and 14 to 16) to ultimately define the overall razor 46. As is well known in the art, the razor cartridge 42 is typically removably securable to the handle 44, but need not be (as would be the case in a disposable version of the razor 46).

For simplicity and clarity, only a single razor blade 40 is shown and described, but it is clear that the invention covers a razor 46, and related razor cartridge 42, in which a plurality of razor blades 40 may be fitted to the razor cartridge 42.

In addition, two versions are envisaged. In one version, the razor cartridge 42 is fixed relative to the handle 44, in which various shaving profiles are achieved by varying the angle of the handle 44, and thus the razor cartridge 42. In the second version, which is the version shown in FIGS. 3 to 17, the razor 46 includes a pivoting arrangement 48 to automatically move the razor cartridge 42 and the razor blade 40, relative to the handle 44, to achieve the various shaving profiles described below.

The razor blade 40 is based on the same shape and configuration as the razor blade 20 shown, and described with reference to, FIG. 2. The key difference is that the razor blade 40 includes a razor blade strip 50 to define a cutting edge 52, which corresponds to the razor blade 20 and its cutting edge 22, but which is significantly narrower than the razor blade 20 (primarily for manufacturing purposes). In addition, the razor blade 40 includes a razor blade flange 54 extending transversely to the razor blade strip 50, to facilitate fitment of the razor blade 40 to the razor cartridge 42.

As already indicated above, the razor blade 40 has a cutting edge 52 which is curved, when viewed in plan, and arced, when viewed from the front. The razor blade 40 is angled (at an obtuse angle 56) relative to a surface to be shaved.

The curved cutting edge 52 defines an arc 58 with two ends 60, 62 and a midpoint 64, the orientation of the razor blade 40 being movable between various positions, as will now be described with reference to FIGS. 3 to 17.

In a first position, with reference to FIGS. 3 to 7, in the case of a flat, planar surface 66 to be shaved, the two ends 60, 62 and the midpoint 64 of the arc 58 are on the same plane to define a flat shaving profile 68, corresponding to the flat surface 66 to be shaved.

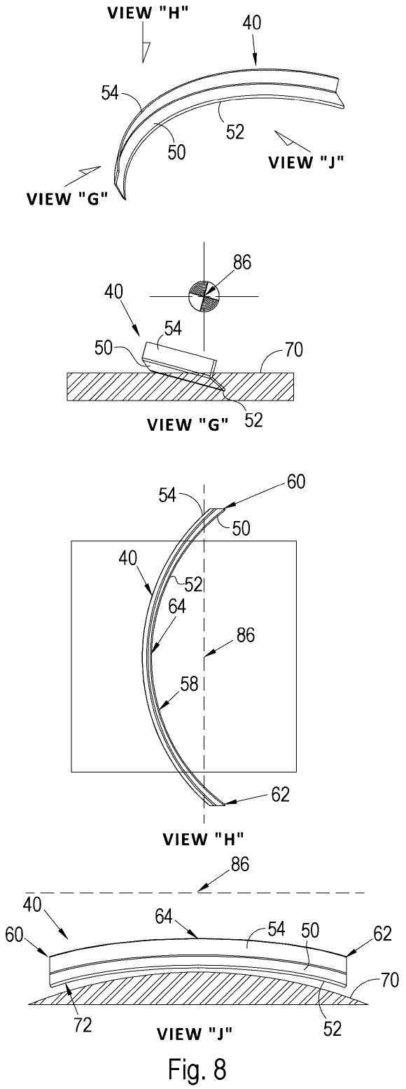

In a second position, with reference to FIGS. 8 to 12, in the case of a convex surface 70 to be shaved, in which the midpoint 64 of the arc 58 is lifted relative to the two ends 60, 62 of the arc 58. This defines a convex shaving profile 72, corresponding to the convex surface 70 to be shaved.

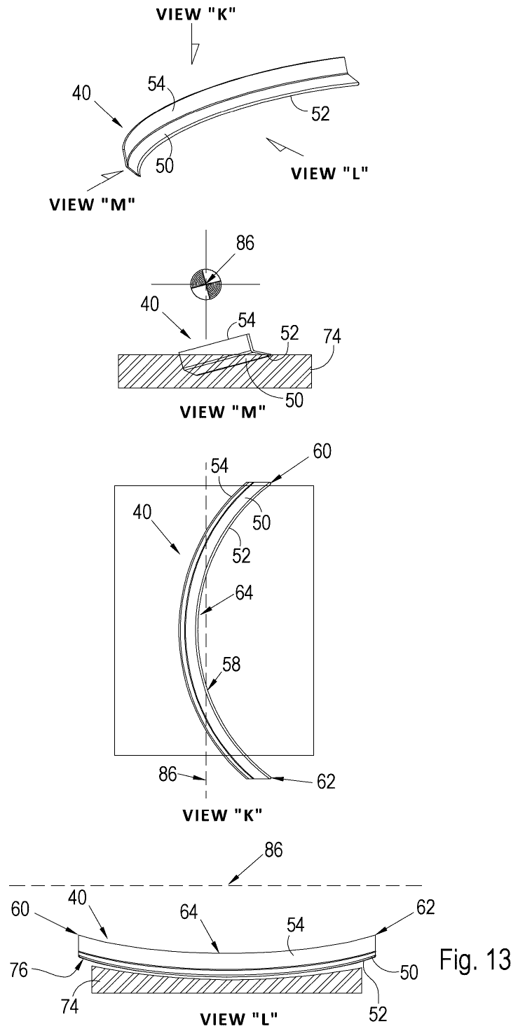

In a third position, with reference to FIGS. 13 to 17, in the case of a concave surface 74 to be shaved, in which the midpoint 64 of the arc 58 is lowered relative to the two ends 60, 62 of the arc 58. This defines a concave shaving profile 76, corresponding to the concave surface 74 to be shaved.

As already indicated above, the razor 46 includes a pivoting arrangement 48 to automatically move the razor cartridge 42 and the razor blade 40, relative to the handle 44, between the first, second and third positions, to achieve the various shaving profiles described above, as the razor blade 40 slides across the surface being shaved. Significantly, the extent that the razor cartridge 42 must pivot or swivel is relatively small. In one version, the razor cartridge 42 only needs to pivot or swivel by around 15 degrees (indicated by angle 78 in FIGS. 10 and 15) to move the razor cartridge 42 from the first to second positions (FIG. 10), and, similarly, 15 degrees to move the razor cartridge 42 from the first to third positions (FIG. 15). In other words, to move the razor cartridge 42 from the second to third positions requires a total pivot or swivel of around 30 degrees.

In an embodiment, the pivoting arrangement 48 includes spaced apart, inwardly facing pins 80 extending from head securing arms 82 provide at a razor cartridge end of the handle 44, the pins being arranged to accommodate complementary recesses define in end side walls of the razor cartridge 42. Clearly, other pivoting arrangements may be used, the overall purpose of the pivoting arrangement being to connect the razor cartridge 42 to the handle 44 in a manner that will allow the movement of the blade 40 in relation to the handle 44 and that the movement will be operative by pressure onto the skin. The movement of the blade 40 may also be achieved by a fine leaf spring at either end of the razor cartridge 42. The swivel movement of the razor cartridge 42 can also easily be achieved when the complete razor, except for the blades, are of a single plastic injection process and there is thinner cross-sectional area providing for flexing at the fixing of the razor cartridge 42. In one version, a limiter or stopper arrangement may be provided to limit the amount of movement that the razor cartridge 42 may have in relation to the handle 44.

In an embodiment, a pixot axis 86 is defined that is spaced from (and above when viewed from the side, as best shown in Views F, G and M in FIGS. 3, 8 and 13, respectively) the curved cutting edge 52 of the razor blade 40. The pivot axis 86 is thus parallel to a chord defined between the two ends 60, 62 of the arc 58, and should in any event be as close to the cutting edge 52 positioned inside the arc scribed by the cutting edge 52.

The shape of the blade 40, in conjunction with the pivoting arrangement 48, is such that the midpoint 64 of the arc 58 can move freely either up or down, relative to the two ends 60, 62 of the arc 58, to permit the razor cartridge 42 to accommodate flat surfaces as well as a conglomeration of both concave and convex shapes, curves and forms. It is thus evident that a razor with the curved blade 40 when mounted on the pivot axis 86 and allowed to swivel freely ensures that a balance is maintained between the contact of the ends and the midpoint 64 of the curved blade 40, keeping it in contact with the skin being shaved. The swivel movement permits infinitely variable convex and concave shapes, curves and profiles to be accommodated automatically during the shaving process, efficiently and with a minimum number of repeated strokes, ultimately resulting in a smooth, clean and comfortable shave in the shortest possible time.

Turning back to FIG. 8, the plan view (H) shows the curved of the cutting edge 52 of the blade 40 and in this presentation the centre point on the curve is allowed to move upward away from the surface 66 with the ends of the blade 40 still in contact with the surface 66. The view (J) shows that there is a curved cutting-edge 52 presented in this manner, which would suit a convex skin profile 66. In practice, shaving pressure via the handle 44 to the blade 40 keeps the cutting edge 52 of the blade 40 in full contact with the skin. This action of movement occurs automatically to keep the full width of the cutting edge 52 in contact with the skin.

Similarly, and with reference now to FIG. 13, when rotated in the opposite direction, the pivot axis 86 permits both ends of the cutting edge 52 of the blade 40 to be raised away from the surface 74 but leaving the apex point of the blade 40 still in contact with the surface 74 as shown in view L. The cutting edge 52 profile so formed has the shape to suit a concave skin profile 74. Once again, this action is attained automatically during the normal shaving action as the cutting edge 52 is allowed to swivel about a pivot to keep it in perfect contact with the skin at all times enabling it to follow the facial profiles perfectly.

As indicated above, in one version, the razor cartridge 42 may be fixed relative to the handle 44, in which the shaving profiles corresponding to the first, second and third positions are achieved by varying the angle of the handle 44, and thus the razor cartridge 42.

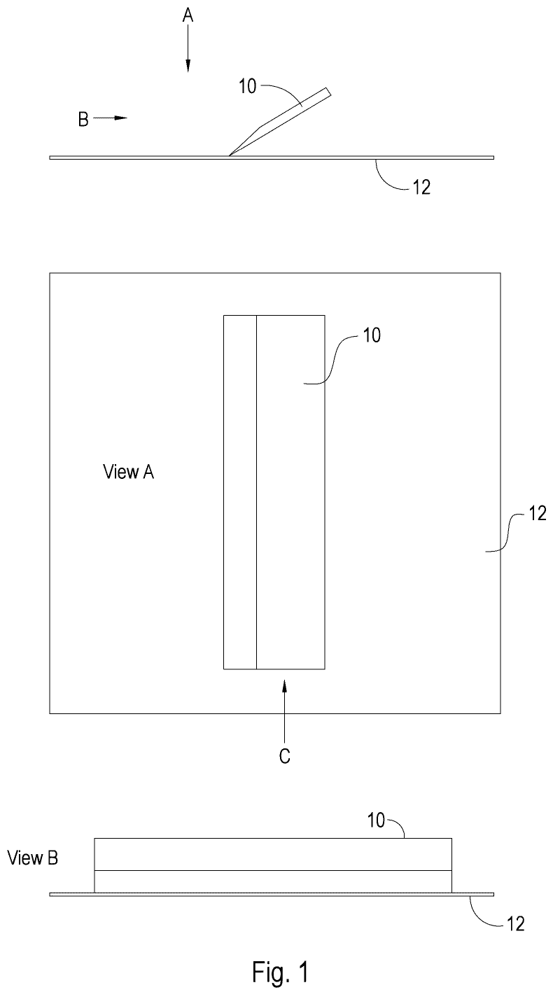

When comparing the conventional straight razor blade 10 shown in FIG. 1 to FIGS. 8 and 13, it can be clearly seen that the blade 10 is unable to adapt to the convex and concave profiles. In addition, a curved blade formed from a portion of a cylinder, although curved as such, does not define an arc, when viewed from the front and rear. Although, geometrically, such a curved blade could adapt to flat, convex and concave profiles, it is unable to do so at an angle relative to a surface to be shaved, which is required practically to facilitate shaving.

1. A razor comprising a razor cartridge fitted with at least one razor blade having a cutting edge which is curved, when viewed in plan, and arced, when viewed from the front, the razor blade in use being angled relative to a surface to be shaved, the curved cutting edge defining an arc with two ends and a midpoint, the orientation of the razor blade being movable between a first position, in the case of a flat surface to be shaved, in which the two ends and the midpoint of the arc are on the same plane to define a flat shaving profile, corresponding to the flat surface to be shaved; a second position, in the case of a convex surface to be shaved, in which the midpoint of the arc is lifted relative to the two ends of the arc, to define a convex shaving profile, corresponding to the convex surface to be shaved; and a third position, in the case of a concave surface to be shaved, in which the midpoint of the arc is lowered relative to the two ends of the arc, to define a concave shaving profile, corresponding to the concave surface to be shaved.

2. The razor of claim 1, wherein the razor blade includes a razor blade flange extending transversely to the curved cutting edge, to facilitate fitment of the razor blade to the razor cartridge.

3. The razor of claim 1, wherein a plurality of razor blades are fitted to the razor cartridge, the razor cartridge in turn being removably securable to a handle.

4. The razor of claim 3, wherein the razor blade is fixed relative to the handle, in which the shaving profiles corresponding to the first, second and third positions are achieved by varying the angle of the handle, and thus the razor blade.

5. The razor of claim 4, wherein the razor includes a pivoting arrangement to automatically pivot the razor blade between the first, second and third positions, as the razor slides across the surface being shaved.

6. The razor of claim 5, wherein the pivoting arrangement includes spaced apart, inwardly facing pins extending from head securing arms provide at a razor cartridge end of the handle, the pins being arranged to accommodate complementary recesses defined in end side walls of the razor cartridge.

7. The razor of claim 6, wherein the pins define a pivot axis therebetween, the pivot axis being above the curved cutting edge of the razor blade, when viewed from the side, and between the midpoint and two ends of the curved cutting edge, when viewed from above.
